(19) United States
(12) Patent Application Publication
(10) Pub. No.: US 2007/0195077 A1
(43) Pub. Date: Aug. 23, 2007

(54) Display device and driving method thereof

(75) Inventors: Soon-hoon Hwang, Yongin-si (KR); Joo-hee Jeon, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/634,869

(22) Filed: Dec. 7, 2006

(30) Foreign Application Priority Data
Feb. 9, 2006 (KR) 2006-12767

(51) Int. Cl. G09G 5/00

(52) U.S. Cl. 345/204

(57) ABSTRACT

A display device and a driving method thereof to increase a display quality include a signal receiver which receive an image signal from an external device, a controller which determines an image quality mode of the received image signal depending on whether recognition information is included in the image signal, and a display which displays the image signal as a certain image depending on the determined image quality mode. The image quality mode of the image signal can be determined as an optimal image quality mode depending on a determination of whether the recognition information is included in the received image signal, and the certain image can be displayed depending on the determined image quality mode so that the display quality of the display device can increase.

### CROSS-REFERENCE TO RELATED APPLICATIONS

This application claims priority from Korean Patent Application No. 10-2006-0012767 filed on Feb. 9, 2006 in the Korean Intellectual Property Office, the disclosure of which is incorporated herein by reference in its entirety.

### BACKGROUND OF THE INVENTION

1. Field of the Invention

The present general inventive concept relates to a display device and a driving method thereof. More particularly, the present general inventive concept relates to a display device that determines an optimal image quality mode of an image signal depending on whether recognition information is included in the image signal received from an external source so that display quality is improved, and a driving method thereof.

2. Description of the Related Art

A digital visual interface (DVI), which is a standard used to transmit digital data generated in a personal computer (PC) to a monitor, has been mainly employed in a device that is connected to a PC such as a projector used for business, a commercial plasma display, and an electric board. Recently, the DVI has been used in an electronic appliance including a digital TV, a set-top box, etc.

The DVI standard has been developed in order to directly transmit digital data without complicated processes. Generally, digital data (transmitted without the DVI standard) is transmitted according to the following complicated processes: a PC generates digital data and converts the digital data into analog data to transmit to a display device, and the display device converts the received analog data back into digital data.

Since the DVI standard was first introduced in 1999, providers of electronic appliances, especially content providers, have focused on the DVI standard, because the DVI standard has a high practical use due, at least in part, to its high-bandwidth digital content protection (HDCP) function, which protects data. Additionally, when using the DVI standard, video can be transmitted without compressing the digital data. Additionally, the content providers expect that the HDCP function of the DVI standard can prevent contents piracy.

In accordance with requests of the content providers, service providers and electronic appliance providers employ the DVI standard instead of using various interfaces such as IEEE 1394 and analog connector.

Generally, a PC monitor needs various functions besides a proper function in which the monitor is connected to a PC to receive an image signal and display an image. The various functions include, for example, a function of displaying an image using an image signal output from an image reproducing device such as a DVD player.

In order to perform the various functions, the image reproducing device outputs a first image signal (hereafter, referred to a first DVI signal) that conforms to the DVI standard, and a PC outputs a second image signal (hereafter, referred to a second DVI signal) that also conforms to the DVI standard, respectively, so that the image reproducing device and the PC are connected to a DVI port on the monitor to transmit the first and/or second DVI signal.

The monitor may have one or more DVI ports. When the monitor has two or more DVI ports, the monitor requires a plurality of scalers to set an image quality mode of the monitor to conform to the first or second DVI signal applied from the image reproducing device or the PC, respectively. Accordingly, this configuration interferes with miniaturization and causes increased manufacturing costs.

Therefore, an image display method is utilized. In the image display method, the monitor configures one DVI port and sets the image quality mode, when a user selects, which conforms to the first and second DVI signal in response to each signal output from various image reproducing devices or PC.

The monitor may set a first image quality mode, which is optimized to conform to the first DVI signal, to display an image if the first DVI signal output from the image reproducing device is input to the monitor. Similarly, the monitor may set a second image quality mode, which is optimized to conform to the second DVI signal, to display an image if the second DVI signal output from the PC is input to the monitor.

In order to achieve this, the image display method is utilized in which the first DVI signal (DVI1) and the second DVI signal (DVI2) are distinguished from each other using different input timing of the first DVI signal (DVI1) and the second DVI signal (DVI2) of a general monitor as illustrated in FIG. 9. Accordingly, an image is displayed according to each optimized image quality mode of the first DVI signal DVI1 and the second DVI signal DVI2, that is, according to an image quality mode with a different luminance value, contrast ratio value, etc.

However, the first DVI signal (DVI1) and the second DVI signal (DVI2) may have the same input timing at a certain resolution as illustrated in FIG. 10. Accordingly, the image display method that distinguishes the first DVI signal DVI1 and the second DVI signal DVI2 by the difference in input timing in order to set an image quality mode to conform to each DVI signal is unable to distinguish the first DVI signal DVI1 and the second DIVS signal DVI2, when these two signals have the same input timing.

In other words, when the first DVI signal DVI1 and the second DVI signal DVI2 are input with the same timing, the monitor cannot distinguish these signals. As a result, the monitor displays an image with a constant regular image quality mode irrespective of the DVI signals received through the DVI port(s).

In this case, the monitor cannot display the image with the optimized image quality mode conforming to each of the first DVI signal DVI1 and the second DVI signal DVI2, but instead displays the image with the regular image quality mode irrespective of the DVI signals. As a result, image quality of the monitor deteriorates.

### SUMMARY OF THE INVENTION

Accordingly, the present general inventive concept provides a display device that distinguishes image signals, which are commonly input to one signal receiver and have the same input timings such that an image can be displayed according to an image quality mode conforming to each of the respective image signals.

The present general inventive concept also provides a driving method to drive a display device.

Additional aspects of the present general inventive concept will be set forth in part in the description which follows and, in part, will be obvious from the description, or may be learned by practice of the general inventive concept.

The foregoing and/or other aspects and utilities of the present general inventive concept may be achieved by providing a display device including a signal receiver which receives an image signal from an external device, a controller which determines an image quality mode of the received image signal depending on whether recognition information is included in the image signal, and a display which displays the image signal as a certain image depending on the determined image quality mode.

The signal receiver may be a digital visual interface (DVI) input unit.

If the recognition information is included in the image signal, the controller may output a first recognition signal of a first logical value, and if the recognition information is not included in the image signal, the controller may output a second recognition signal of a second logical value.

The device may further include a storage which stores the first recognition signal and the second recognition signal. The controller may read the first recognition signal and the second recognition signal from the storage by a certain period to compare the read recognition signals with a pre-set reference value.

The signal receiver may commonly receive image signals from a plurality of output sources as the external device.

The output sources of the image signals, which can be commonly connected to the signal receiver, may be a computer and an image reproducing device which extracts data from an image recording medium as the image signal and supports a high-bandwidth digital content protection (HDCP).

The recognition information may include an impulse waveform having a predetermined period of time, the impulse waveform may include a plurality of impulses having the predetermined period of time therebetween, the image signal comprises a plurality of data signals having an interval therebetween, and the data signals are included in the predetermined period of time. The recognition information may include a number of logic signals, and the controller compares each of the logic signals with a reference to determine that the recognition information is included in the image signal. The controller may select one of predetermined image quality modes as the image quality mode of the received image signal according to a determination of whether the recognition information is included in the image signal.

The foregoing and/or other aspects and utilities of the present general inventive concept may also be achieved by providing a driving method of a display device, the method including receiving an image signal, determining whether recognition information is included in the received image signal, and setting a display device to display an image with each different image quality mode depending on the determination of whether the recognition information is included in the image signal.

The method may further include determining whether an external device as an output source of the image signal received from an exterior is connected to the display device.

The determining of whether the recognition information is included in the received image signal may include outputting a first recognition signal if the recognition information is applied, and outputting a second recognition signal if the recognition information is not applied, storing the first recognition signal or the second recognition signal, and reading the stored first recognition signal or second recognition signal by a certain period and comparing the read signal with a pre-set reference value to output a control signal.

If the recognition information is applied, the first recognition signal of a logical value may be output.

The reading of the stored first recognition signal by a certain period and comparing the read signal with a pre-set reference value to output a control signal may comprise comparing the stored first recognition signal with the reference value of another logical value to output the first control signal.

If the recognition information is not applied, the second recognition signal of a second logical value may be output.

The reading of the stored second recognition signal by a certain period and comparing the read signal with a pre-set reference value to output a control signal may comprise comparing the stored second recognition signal with the reference value of another logical value to output the second control signal.

The image signal including the recognition information may be received through an image reproducing device that supports an HDCP, and the image signal including no recognition information may be received through a computer.

The foregoing and/or other aspects and utilities of the present general inventive concept may also be achieved by providing a computer readable recording medium containing computer readable codes to perform a method of determining an image quality mode, the method including receiving an image signal, determining whether recognition information is included in the received image signal, and setting a display device to display an image with each different image quality mode depending on a determination of whether the recognition information is included in the image signal.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a view illustrating an image processing system according to an exemplary embodiment of the present general inventive concept;

FIG. 2 is a schematic block diagram illustrating a display device of the system of FIG. 1, according to another exemplary embodiment of the present general inventive concept;

FIG. 3 is a flowchart illustrating a driving method to drive a display device according to another exemplary embodiment of the present general inventive concept;

FIG. 4 illustrates wave forms of DDC (direct digital control) signals;

FIG. 5 is a flowchart illustrating operation of a controller of the display device of FIG. 2, according to another exemplary embodiment of the present general inventive concept;

FIG. 6 is a view illustrating a driving operation of a storage depending on the operation of the controller of FIG. 5, according to another exemplary embodiment of the present general inventive concept;

FIG. 7 is a flowchart illustrating operation of a controller of the display device of FIG. 2, according to another exemplary embodiment of the present general inventive concept;

FIG. 8 is a view illustrating a driving operation of a storage depending on the operation of the controller of FIG. 5, according to another exemplary embodiment of the present general inventive concept;

FIG. 9 is a view illustrating an image signal according to a comparative example; and

FIG. 10 is a view illustrating an image signal according to another comparative example.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

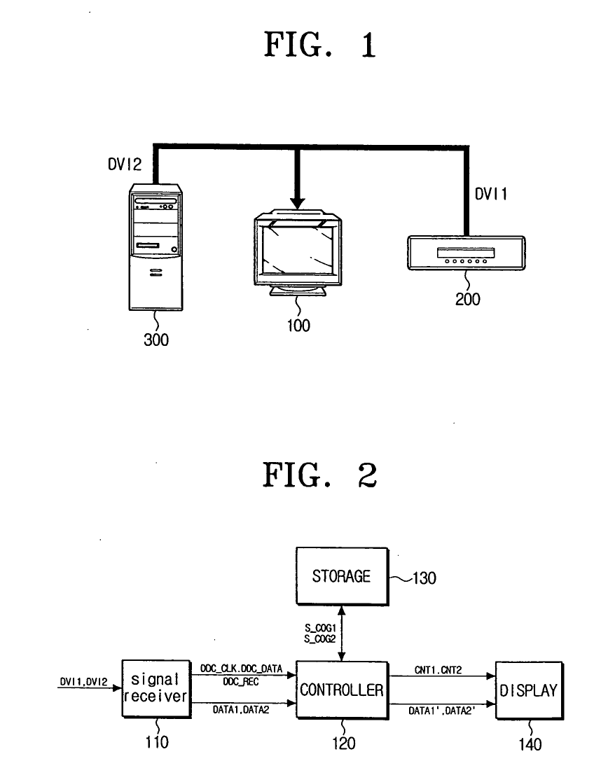

FIG. 1 is a view illustrating an image processing system according to an exemplary embodiment of the present general inventive concept.

Referring to FIG. 1, the image processing system according to an exemplary embodiment of the present general inventive concept includes a display device 100 which displays a predetermined image, a first host device 200 which outputs a first image signal (hereafter, referred to as a first DVI signal DVI1) that conforms to a DVI standard, and a second host device 300 which outputs a second image signal (hereafter, referred to as a second DVI signal DVI2) that also conforms to the DVI standard.

In particular, the first host device 200 may be an image reproducing device which extracts data from an image recording medium. For example, the first host device 200 may be a DVD player which extracts image data from a digital versatile disc (DVD).

Content providers store data protection information such as a high-bandwidth digital content protection (HDCP) information on the image recording medium, such as the DVD, to prevent contents piracy. The HDCP information is scrambled and output by the DVD player. The HDCP information is provided to a DVI port (not illustrated) at the display device 100 as the first DVI signal DVI1 together with image data extracted from the image recording medium.

The second host device 300 may be a processing device such as a personal computer (PC) which processes data input by a user. The second host device 300 processes the data to output to the display device 100. The second DVI signal DVI2 output from the second host device 300 does not include the HDCP information included in the first DVI signal DVI1. The second DVI signal DVI2 includes digitalized image data, as well as a DDC (direct digital control) data signal DDC_DATA, and a DDC clock signal DDC_CLK that provide information about the second host device 300. The second DVI signal DVI2 is provided to the DVI port at the display device 100.

As illustrated in Table 1 (below), the first DVI signal DVI1 output from the image reproducing device includes the HDCP information and recognition information DDC_REC output at a predetermined period when the image reproducing device is connected to the DVI port. The second DVI signal DVI2 output from the PC includes the DDC data signal DDC_DATA and the DDC clock signal DDC_CLK to set a display environment such as an image quality mode of the display device 100.

TABLE 1

| | HDCP, DDC_REC | DDC_DATA, DDC_CLK |
|---|---|---|
| The first DVI signal | including | excluding |
| The second DVI | excluding | including |
| signal | | |

The display device 100 receives the first DVI signal DVI1 and the second DVI signal DVI2 output from the first host device 200 and the second host device 300, respectively, and displays a predetermined image using the image data included in the first DVI signal DVI1 and the second DVI signal DVI2. In order to achieve this, the display device 100 has the DVI port to receive the first DVI signal DVI1 and the second DVI signal DVI2.

The display device 100 may have one DVI port to commonly receive both the first DVI signal DVI1 and the second DVI signal DVI2. Alternatively, the display device 100 may have a plurality of DVI ports to respectively receive each of the first DVI signal DVI1 and the second DVI signal DVI2 from a plurality of host devices.

The image processing system according to the present embodiment selectively connects the first host device 200 or the second host device 300 through one DVI port to the display device 100 depending on a user's request to display a desired image.

Operations of the image processing system will now be described as follows.

When displaying an image using the first DVI signal DVI1 output from the first host device 200, a user first connects a communication cable, which is connected to the first host device 200, to the DVI port on the display device 100. The display device 100 and the first host device 200 perform hot plug detect (HPD) operations therebetween to determine whether the first DVI signal DVI1 can be received, that is, whether the display device 100 and the first host device 200 are connected to each other and are authenticated devices.

If it is determined that the display device 100 and the first host device 200 are connected to each other and are authenticated devices, the first host device 200 and the display device 100 perform HDCP mutual authentication operations. In the HDCP mutual authentication operation, the display device 100 accurately de-scrambles the image signal, which is scrambled and provided by the first host device 200, and the authentication is performed by authentication and key exchange (AKE) operations using a mutual key value and a cipher calculation value.

After the HDCP mutual authentication operation is performed between the display device 100 and the first host device 200, the first host device 200 outputs the image data to the display device 100 to display the predetermined image.

When trying to display the predetermined image using the image data output from the second host device 300, a user first connects a second communication cable, which is connected to the second host device 300, to the DVI port of the display device 100.

The second host device 300 determines whether the display device 100 is connected to the second host device 300 and outputs image data to the display device 100 so that a certain image can be displayed.

The display device 100 receives the first DVI signal DVI1 and the second DVI signal DVI2 through the one DVI port from the first host device 200 and the second host device 300, and distinguishes the first DVI signal and the second DVI signal. Accordingly, the display device 100 sets an image quality of the display device 100 to a first image quality mode model and a second image quality mode mode2, which are optimal image quality modes of the first and second DVI signals DVI1 and DVI2, respectively. This operation is described as follows.

FIG. 2 is a schematic block diagram illustrating the display device 100 of FIG. 1.

Referring to FIG. 2, the display device 100 of the present embodiment includes a signal receiver 110 which receives the first and second DVI signals DVI1 and DVI2, a controller 120 which controls operations of the display device 100, a storage 130 which stores a first and a second recognition signals S_COG1 and S_COG2, and a display 140 which displays an image.

In particular, the signal receiver 110 is connected to the first host device 200 and the second host device 300 of FIG. 1 to receive the first DVI signal DVI1 and the second DVI signal DVI2 output from the respective host devices 200 and 300. The signal receiver 110 refers to the DVI port which is described above with reference to FIG. 1. Additionally, the signal receiver 110 and/or the DVI port may be a DVI input unit.

The controller 120 controls the operations of the display device 100. For example, the controller 120 controls output timing of a first image data DATA1 and a second image data DATA2 included in each of the first DVI signal DVI1 and the second DVI signal DVI2 so that the controlled image data DATA1′ and DATA2′ can be output to the display 140.

The controller 120 of the display device 100 of the present embodiment sets the image quality mode of the display device 100 based on whether the recognition information is included in the received DVI signals DVI1 and DVI2, and determines whether the display device 100 is connected to the first host device 200 and/or the second host device 300.

The first DVI signal DVI1 includes the HDCP information and the recognition information DDC_REC, and the second DVI signal DVI2 includes a direct digital control (DDC) signal including the DDC data signal DDC_DATA and the DDC clock signal DDC_CLK. The DDC signal is to set a display environment such as the image quality mode of the display device 100 in response to the second DVI signal DVI2.

The controller 120 generates and outputs the first recognition signal S_COG1 or the second recognition signal S_COG2 depending on whether the recognition information DDC_REC included in the first DVI signal DVI1 is applied. The controller 120 outputs a first control signal CNT1 and a second control signal CNT2 to set the image quality mode of the display 100 based on the generated first and second recognition signals S_COG1 and S_COG2.

If it is configured as a single chip set, the controller 120 has DVI_CHK pin and continuously checks signals input to the DVI_CHK pin so as to determine whether the first host device 200 and/or the second host device 300 are connected.

The signal receiver 110 further includes a DDC input pin (not illustrated) to receive the DDC data signal DDC_DATA and the DDC clock signal DDC_CLK, and the controller 120 further includes a DVI_GPIO pin to connect to the DDC input pin. The recognition information DDC_REC is commonly input during each different time band through a DDC receiver, that is, the DDC input pin.

In other words, if the first host device 200 is connected to the display device 100, the recognition information DDC_REC is input through the DDC input pin. Similarly, if the second host device 300 is connected to the display device 100, the DDC data signal DDC_DATA and the DDC clock signal DDC_CLK may be input through the DDC input pin.

The storage 130 stores the first recognition signal S_COG1 or the second recognition signal S_COG2 which are received from the controller 120, and reads the stored first recognition signal S_COG1 and second recognition signal S_COG2 based on the control of the controller 120.

More specifically, the storage 130 may be buffer which shifts the first and second recognition signals S_COG1 and SCOG2 when these signals are input. If the controller 120 is configured as the single chip set, the storage 130 may be included in the single chip set.

The display 140 is set to the first image quality mode model and the second image quality mode mode2 that are suitable for the first DVI signal DVI1 and the second DVI signal DVI2 that are input, in response to the first and second control signals CNT1 and CNT2 output from the controller 120. The display 140 displays the predetermined image for each image data DATA1 and DATA2 included in the first and the second DVI signals DVI1 and DVI2.

The operations of the display device 100 will be described hereinafter.

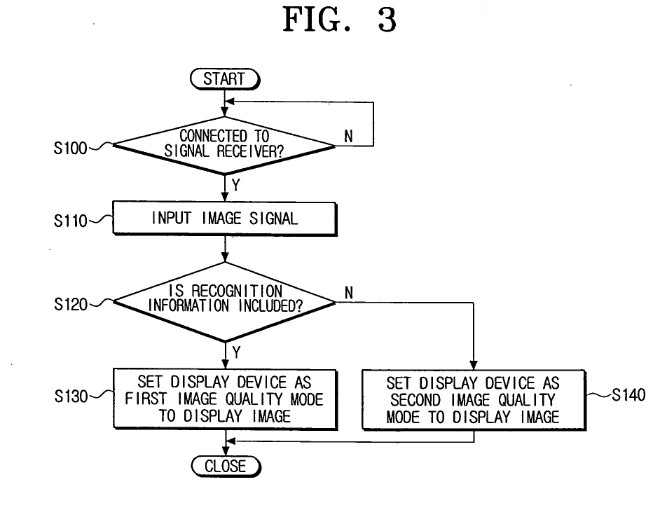

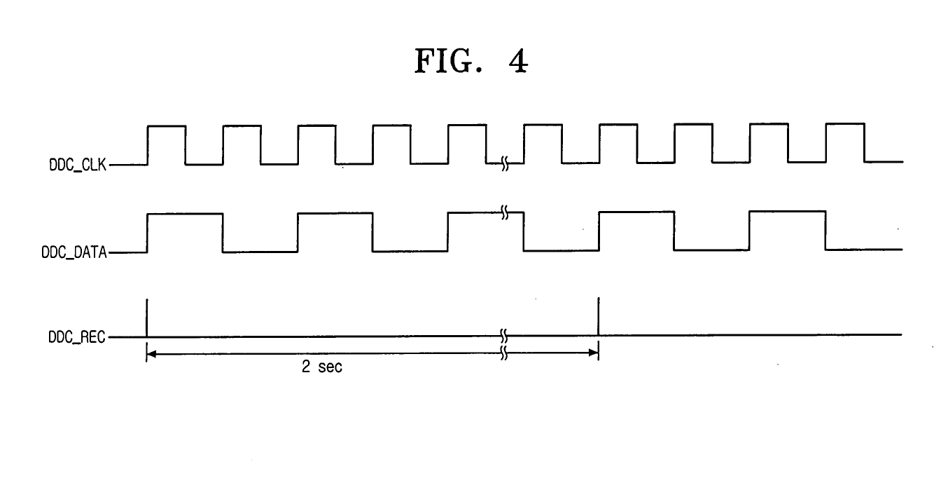

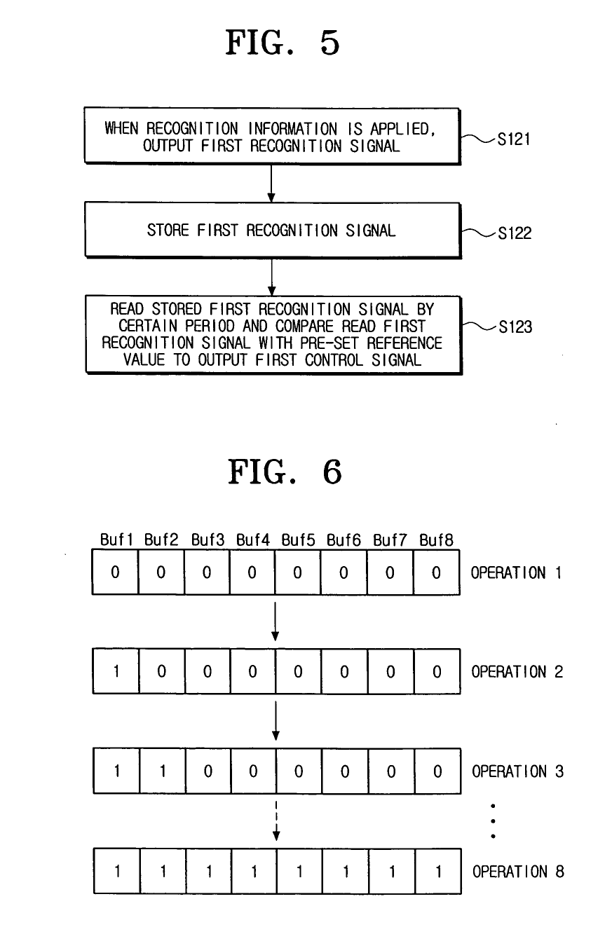

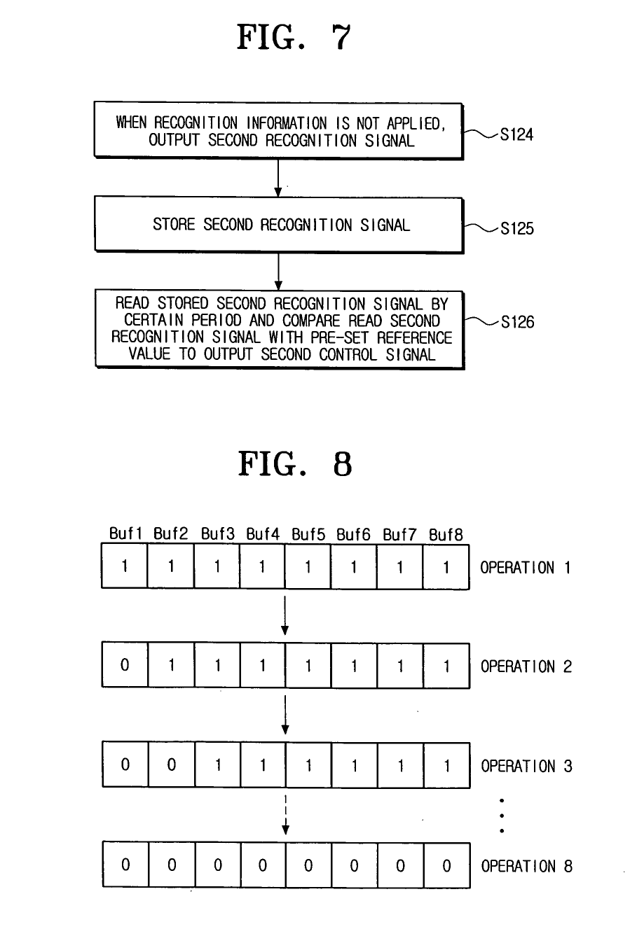

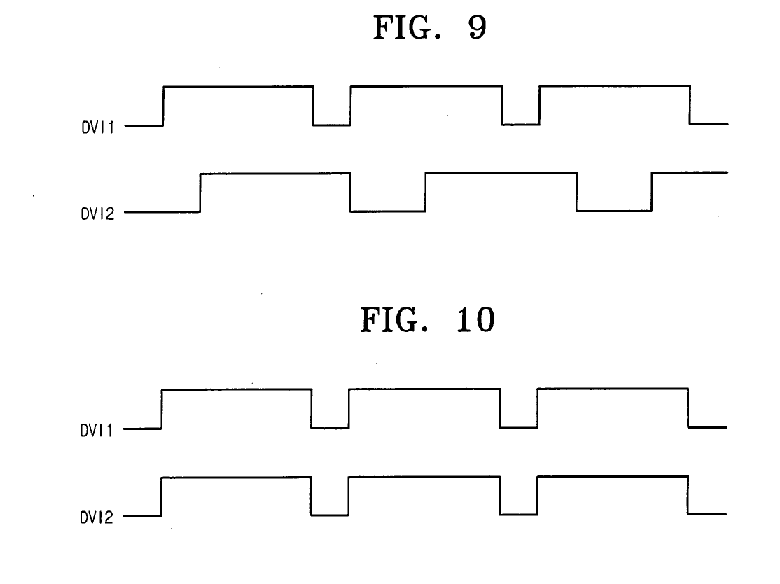

FIG. 3 is a flowchart illustrating a driving method to drive the display device 100 of FIG 2, and FIG. 4 illustrates waveforms of the DDC signals. FIG. 5 is a flowchart illustrating an operation of the controller 120 of FIG. 2, and FIG. 6 is a view illustrating a driving of the storage 130 depending on the operation of the controller 120 of FIG. 5. FIG. 7 is a flowchart illustrating an operation of the controller 120 of FIG. 2, according to another exemplary embodiment of the present general inventive concept, and FIG. 8 is a view illustrating a driving of the storage 130 depending on the operation of the controller 120 of FIG. 7, according to another exemplary embodiment of the present general inventive concept.

Referring to FIGS. 1 through 3, the driving method of the display device 100 of the present embodiment includes operations of determining whether an output source of image signals is connected to the display device 100 (operation S100), and receiving the image signals (operation S110) if the output source is connected to the display device 100. It is then determined whether the recognition information is included in the input image signal (operation S120), and if it is determined that the recognition information is included in the input image signal, the display device 100 is set to the first image quality mode to display an image (operation S130). On the other hand, if the recognition information is not included in the input image signal, the display device 100 is set to the second image quality mode to display the image (operation S140).

In the operation S100, when the output source of the first DVI signal DVI1 (that is, the first host device 200) or the output source of the second DVI signal DVI2 (that is, the second host device 300) are selectively connected to the display device 100 by a user, the display device 100 determines whether the display device 100 is connected to the first host device 200 and/or the second host device 300. It is also possible that both the first host device 200 and the second host device 300 may be connected to the display device 100 as the output source of the first DVI signal DVI1 (that is, the first host device 200) or the output source of the second DVI signal DVI2, respectively, and that the first DVI signal DVI1 and the second DVI signal DVI2 may be selectively or simultaneously input to the display device 100.

The controller 120, for example, may continuously determine whether signals are applied to the signal receiver 110 (that is, the DVI port) of the display device 100.

In the operation S110, the first DVI signal DVI1 is input to the display device 100 from the first host device 200 or the second DVI signal DVI2 is input to the display device 100 from the second host device 300, which may be selectively connected to the display device 100 by a user in the operation S100.

In the operation S120, the display device 100 determines whether the DVI signal input to the display device 100 includes the recognition information DDC_REC so that the controller 120 can determine whether the DVI signal input to the display device 100 is the first DVI signal DVI1 output from the first host device 200 or the second DVI signal DVI2 output from the second host device 300.

Accordingly, the display device 100 determines whether the DVI signal is the first DVI signal DVI1 or the second DVI signal DVI2 depending on whether the recognition information DDC_REC is applied in an impulse waveform having a certain period as illustrated in FIG. 4. The impulse waveform may include a plurality of impulses having an interval of the certain period therebetween. In FIG. 4, the DDC data signal DDC_DATA and the DDC clock signal DDC_CLK are input during the same time band with the recognition information DDC_REC. Additionally, the DDC data signal DDC_DATA and the DDC clock signal DDC_CLK are input through the common DDC input pin during each different time band.

A method of determining the recognition information DDC_REC will now be described as follows.

Referring to FIG. 5, the operation S120 of FIG. 3 may include operations of outputting the first recognition signal S_COG1 when the recognition information DDC_REC is applied (operation S121), storing the first recognition signal S_COG1 (operation S122), and reading the stored first recognition signal S_COG1 at a certain period and comparing the read first recognition signal S_COG1 with a pre-set reference value REF to output the first control signal CNT1 (S123).

Referring to FIG. 7, the operation S120 of FIG. 3 may include operations of outputting the second recognition signal S_COG2 when the recognition information DDC_REC is not applied (operation S124), storing the second recognition signal S_COG2 (operation S125), and reading the stored second recognition signal S_COG2 at a certain period and comparing the read second recognition signal S_COG2 with a pre-set reference value REF to output the second control signal CNT2 (operation S126).

In the operation S121, when the first DVI signal DVI1 is applied to the controller 120, the first recognition signal S_COG1 is output. The first DVI signal DVI1 includes the first image data DATA1, the HDCP information, and the recognition information DDC_REC. The controller 120 counts a number of inputs when the recognition information DDC_REC is input over a certain period such as a 2 second period as illustrated in FIG. 4, and outputs the first recognition signal S_COG1 of logical value “1.”

In the operation S122, the storage 130 stores the first recognition signal S_COG1 of logical value “1” output from the controller 120. In order to achieve this, the controller 120 counts the recognition information DDC_REC only when the recognition information DDC_REC conforms to a certain reference.

In particular, the controller 120 counts the recognition information DDC_REC when the recognition information DDC_REC is applied with a voltage over a certain potential level so that the controller 120 can be prevented from understanding noise as the recognition information DDC_REC when the recognition information DDC_REC is not actually being applied.

In the operation S123, the first recognition signal S_COG1 of the logical value “1” stored in the storage 130 is read under the control of the controller 120, and the first recognition signal S_COG1 is compared with the pre-set reference value REF preset in the controller 120 so that the first control signal CNT1 is output. The pre-set reference value REF may be, for example, logical value “0.”

Referring to FIGS. 2 to 6, the storage 130 sequentially receives and stores the first recognition signal S_COG1. If the storage 130 is configured as buffers Buf1, . . . , Buf8 as illustrated in FIG. 8, that shift the first recognition signal S_COG1, the controller 120 reads the first recognition signal S_COG1 stored in the storage 130 during a certain period and compares the read first recognition signal S_COG1 with the pre-set reference value REF.

For example, if the controller 120 can process data of 8 bit units, 8 bits of buffer Buf1, . . . , Buf8 are employed, and the first recognition signal S_COG1 of the 8 bit unit, which is stored in the buffers Buf1, . . . , Buf8, is read so as to be compared with the pre-set reference value REF.

As a result of the comparison with the pre-set reference value REF, if the first recognition signal S_COG1 of the 8 bit unit, which are sequentially input to the buffers Buf1, . . . , Buf8 and shifted, has values greater than the pre-set reference value REF (that is, the logical value “0”) as illustrated in OPERATION 2 to OPERATION 8 of FIG. 6, the controller 120 recognizes that the first DVI signal DVI1 is received from the first host device 200. Accordingly, the controller 120 outputs the first control signal CNT1 to set the display 140 to the first image quality mode model which is an optimal image quality mode for the first host device 200 or the first DVI signal DVI1. In the present embodiment, when each of a predetermined number of bits, for example, 8 bits, is compared with the pre-set reference value REF, and the respective bits are determined to be greater than the pre-set reference value REF, the controller 120 may determine that the DVI signal as the first DVI signal DVI1.

In the operation S124, as the second DVI signal DVI2 is applied to the controller 120, the second recognition signal S_COG2 is output. The second DVI signal DVI2 includes the second image data DATA2 and the DDC signal, which includes the DDC data signal DDC_DATA and the DDC clock signal DDC_CLK.

Since the second DVI signal DVI2 does not include the recognition information DDC_REC and the controller 120 counts the recognition information DDC_REC, the controller 120 outputs the second recognition signal S_COG2 of the logical value “0” when the second DVI signal DVI2 is applied.

In the operation S125, the storage 130 stores the second recognition signal S_COG2 of the logical value “0” output from the controller 120 based on the control of the controller 120.

In the operation S126, the second recognition signal S_COG2 of the logical value “0” stored in the storage 130 is read based on the control of the controller 120, and the read second recognition signal S_COG2 is compared with the pre-set reference value REF (for example, the logical value “0”) so that the second control signal CNT2 is output.

The storage 130 sequentially receives the second recognition signal S_COG2, and if the storage 130 is configured as buffers Buf1, . . . , Buf8 that shift the second recognition signal S_COG2, the storage 130 reads the data stored in the storage 130 to compare the read data with the pre-set reference value REF.

For example, if the controller 120 can process data of the 8 bit unit, 8 bits of buffer Buf1, . . . , Buf8 are employed and the second recognition signal S_COG2 of the 8 bit unit, which is stored in the buffers Buf1, . . . , Buf8, is read so as to be compared with the pre-set reference value REF.

As a result of the comparison with the pre-set reference value, if the second recognition signal S_COG2 of the 8 bit unit has the same values as the pre-set reference value REF, as illustrated in OPERATION8 of FIG. 6, the controller 120 recognizes that the second DVI signal DVI2 is received from the second host device 300, and outputs the second control signal CNT2 to set the display 140 as the second image quality mode mode2 which is an optimal image quality mode for the second host device 300 or the second DVI signal DVI2.

The aforementioned operations S121 through S123 of FIG. 5 illustrate an example in which a connection between the display device 100 and the second host device 300 is changed to a connection between the display device 100 and the first host device 200. The operations S124 through S126 of FIG. 7 illustrate an example in which a connection between the display device 100 and the first host device 200 is changed to a connection between the display device 100 and the second host device 300.

However, the first control signal CNT1 and the second control signal CNT2 can be output not only in a case in which the connection between the display device 100 and the first host device 200 or the second host device 300 has been changed, but also a case in which the storage 130 is reset when the display device 100 is initially driven, or when the display device 100 is connected to one host device to be continuously driven. In these cases, a number of inputs of the recognition information DDC_REC are counted and the recognition signals S_COG1, S_COG2 stored in the storage 130 are determined whether to be identical with the pre-set reference value REF so that the first control signal CNT1 and the second control signal CNT2 are output.

It should be understood that the present embodiment is intended to be exemplary and that various changes can be made to this embodiment. For example, the reference value REF may be the logical value “1” to drive the display device 100 instead of the logical “0” value, or the operations S121-S123 and S124-S126 may each employ a different reference value REF.

In other words, the display device 100 determines whether the DDC recognition signal DDC_REC is included in the DVI signal that is input to the display device 100 to output the recognition signals S_COG1 and S_COG2, and compares the recognition signals S_COG1 and S_COG2 during a certain period with the pre-set reference value REF so as to output the first control signal CNT1 and the second control signal CNT2, which set an image quality mode of the display 140.

Referring back to FIG. 3, in the operation S130, the display 140 is set to the first image quality mode mode1 in response to the first control signal CNT1 that is output from the controller 120. Accordingly, the display 140 displays the first image data DATA1′, the output timing of which is controlled by the controller 120, as an image of the first image quality mode mode1.

In the operation S140, the display 140 is set to the second image quality mode mode2 in response to the second control signal CNT2 that is output from the controller 120, displays the second image data DATA2′, the output timing of which is controlled by the controller 120, as an image of the second image quality mode mode2.

In other words, the first DVI signal DVI1 and the second DVI signal DVI2, which are input by the display device and the driving method thereof, are divided depending on whether the signals include the recognition information DDC-REC, and the image quality mode of the display device is set as an optimal image quality mode for each DVI signal DVI1, DVI2 so that an image is displayed.

The present general inventive concept can also be embodied as computer-readable codes on a computer-readable recording medium to perform the above-described method. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments to accomplish the present general inventive concept can be easily construed by programmers skilled in the art to which the present general inventive concept pertains.

As described above, according to the display device and the driving method thereof according to embodiments of the present general inventive concept, the image signal is divided into one having the data protection information and the other having DDC signal depending on whether an input image signal includes recognition information, and optimal image quality modes for each image signal are set so that an image can be displayed with an optimal image quality mode for each image signal even when input image signals are changed. Accordingly, the display quality of the display device can increase.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display device comprising:
a signal receiver which receives an image signal from an external device;
a controller which determines an image quality mode of the received image signal depending on whether recognition information is included in the image signal; and
a display which displays the image signal as a certain image depending on the determined image quality mode.

2. The device as claimed in claim 1, wherein the signal receiver comprises a digital visual interface (DVI) input unit.

3. The device as claimed in claim 2, wherein if the recognition information is included in the image signal, the controller outputs a first recognition signal of a first logical value, and if the recognition information is not included in the image signal, the controller outputs a second recognition signal of a second logical value.

4. The device as claimed in claim 3, further comprising:
a storage which stores the first recognition signal and the second recognition signal,
wherein the controller reads the first recognition signal and the second recognition signal from the storage by a certain period to compare the read recognition signals with a pre-set reference value.

5. The device as claimed in claim 1, wherein the image signal comprises at least one of a plurality of image signals received from a plurality of output sources as the external device, and the signal receiver receives the image signals from the plurality of output sources.

6. The device as claimed in claim 5, wherein the output sources of the image signals are commonly connected to the signal receiver and comprise a computer and an image reproducing device which extracts data from an image recording medium as the image signal and supports a high-bandwidth digital content protection (HDCP).

7. The device as claimed in claim 1, wherein the recognition information comprises an impulse waveform having a predetermined period of time.

8. The device as claimed in claim 7, wherein the impulse waveform comprises a plurality of impulses having the predetermined period of time therebetween.

9. The device as claimed in claim 7, wherein the image signal comprises a plurality of data signals having an interval therebetween, and the data signals are included in the predetermined period of time.

10. The device as claimed in claim 1, wherein the recognition information comprises a number of logic signals, and the controller compares each of the logic signals with a reference to determine that the recognition information is included in the image signal.

11. The device as claimed in claim 1, wherein the controller selects one of predetermined image quality modes as the image quality mode of the received image signal according to a determination of whether the recognition information is included in the image signal.

12. A driving method of a display device, the method comprising:
receiving an image signal;
determining whether recognition information is included in the received image signal; and
setting a display device to display an image with each different image quality mode depending on a determination of whether the recognition information is included in the image signal.

13. The method as claimed in claim 12, further comprising:
determining whether an external device as an output source of the image signal is connected to the display device.

14. The method as claimed in claim 12, wherein the determining of whether the recognition information is included in the received image signal comprises:
if the recognition information is applied, outputting a first recognition signal, and if the recognition information is not applied, outputting a second recognition signal;
storing the first recognition signal or the second recognition signal; and
reading the stored first recognition signal or second recognition signal by a certain period and comparing the read signal with a pre-set reference value to output a control signal.

15. The method as claimed in claim 14, wherein if the recognition information is applied, a logical value is output as the first recognition signal.

16. The method as claimed in claim 15, wherein the reading of the stored first recognition signal by the certain period and comparing the read signal with the pre-set reference value to output the control signal comprise comparing the stored first recognition signal with the reference value of another logical value to output the first control signal.

17. The method as claimed in claim 14, wherein if the recognition information is not applied, a logical value is output as the second recognition signal.

18. The method as claimed in claim 17, wherein the reading of the stored second recognition signal by the certain period and the comparing of the read signal with the pre-set reference value to output a control signal comprise comparing the stored second recognition signal with the reference value of another logical value to output the second control signal.

19. The method as claimed in claim 12, wherein the image signal including the recognition information is received through an image reproducing device that supports an HDCP, and the image signal including no recognition information is received through a computer.

20. A computer readable recording medium containing computer readable codes to perform a method of determining an image quality mode, the method comprising:
receiving an image signal;
determining whether recognition information is included in the received image signal; and
setting a display device to display an image with each different image quality mode depending on a determination of whether the recognition information is included in the image signal.
